(19) United States
(12) Patent Application Publication
(10) Pub. No.: US 2026/0109401 A1
(43) Pub. Date: Apr. 23, 2026

(54) ALTERNATIVE CONTROL METHOD FOR A STEER-BY-WIRE SYSTEM

(71) Applicant: Steering Solutions IP Holding Corporation, Saginaw, MI (US)

(72) Inventor: Sarin Kodappully, Midland, MI (US)

(21) Appl. No.: 18/923,214

(22) Filed: Oct. 22, 2024

(51) Int. Cl. B62D 6/00; B62D 5/04

(52) U.S. Cl. CPC B62D 6/007; B62D 5/0421; B62D 5/046

(57) ABSTRACT

A method for controlling a roadwheel actuator (RWA) of a vehicle includes, using one or more processors, determining an expected cornering state of the vehicle by determining at least one of an expected yaw rate an expected lateral acceleration of the vehicle, determining an actual cornering state of the vehicle by determining at least one of an actual yaw rate and an actual lateral acceleration of the vehicle, determining a cornering state error based on the expected cornering state of the vehicle and the actual cornering state of the vehicle, generating an RWA control signal based on the cornering state error, and controlling at least one function of the vehicle using the RWA control signal.

### TECHNICAL FIELD

This disclosure relates to providing lateral control of a vehicle to a driver in response to malfunctions of a steer-by-wire (SbW) steering system.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to systems and methods configured to provide lateral control of a vehicle to a driver in response to malfunctions of a steer-by-wire (SbW) steering system.

An aspect of the disclosed embodiments includes A method for controlling a roadwheel actuator (RWA) of a vehicle includes, using one or more processors, determining an expected cornering state of the vehicle by determining at least one of an expected yaw rate an expected lateral acceleration of the vehicle, determining an actual cornering state of the vehicle by determining at least one of an actual yaw rate and an actual lateral acceleration of the vehicle, determining a cornering state error based on the expected cornering state of the vehicle and the actual cornering state of the vehicle, generating an RWA control signal based on the cornering state error, and controlling at least one function of the vehicle using the RWA control signal.

In another aspect, a system is configured to perform the functions of various methods described herein. In another aspect, a processor is configured to execute instructions store in memory to perform the functions of various methods described herein.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2A generally illustrates an example rack or RWA controller and column or handwheel actuator (HWA) of a steering system configured to perform RWA control according to the principles of the present disclosure.

FIG. 2B generally illustrates an example of an RWA control calculation system according to the principles of the present disclosure.

FIG. 3 is a flow diagram generally illustrating a method for performing RWA control according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

A SbW steering system may include at least one handwheel actuator (HWA), such as a steering wheel, which is used by a driver to control the vehicle laterally, and at least one roadwheel actuator (RWA), which is used to control a steered axle of the vehicle and create lateral motion of the vehicle responsive to movement of the HWA. A SbW system may further include a controller, such as a domain controller, configured to store and execute control logic.

SbW systems have some advantages over other types of steering systems, such as EPS steering systems. For example, SbW systems are not limited by a mechanical linkage between the HWA and the RWA. Accordingly, SbW systems may have more efficient packaging, increased crashworthiness and cost savings, and improved interaction with automated driving and advanced driver assistance systems (and corresponding safety and performance benefits).

In SbW systems without mechanical, electrical, or software backup or mitigation strategies or techniques, deactivation of SbW control may result loss of ability to control the vehicle laterally. Accordingly, various mitigation techniques may be used to expand the operational capacity of SbW and to ensure that the driver maintains some lateral control of the vehicle when the SbW system malfunctions. These mitigation techniques may include redundant sensors, actuators, and communication paths, various degraded-state control strategies within the SbW system, alternate methods of lateral control (e.g., brake or powertrain torque vectoring methods such as Steer-by-Brake (SbB) techniques), etc.

However, degraded-state and other mitigation techniques typically provide less capability to control the vehicle laterally relative to a fully operational SbW system. Further, these mitigation techniques each provide different levels of capability for controlling the vehicle laterally relative to one another.

Accordingly, SbW systems and methods according to the present disclosure (e.g., RWA control systems and methods) are configured to provide increased control capabilities during implementation of one or more mitigation/control techniques and expand the capabilities and operational use-cases of these techniques. As one example, these systems and methods are configured to provide lateral control of the vehicle to the driver in the absence of feedback or control from the RWA or RWA sensors. As one example, the systems and methods of the present disclosure are configured to generate an RWA control signal to control the RWA in response to a determination that one or more of the RWA controller, rack position controller, etc. are not controlling rack position in a manner consistent with driver intent. The RWA control techniques of the present disclosure strategy can be used to expand operational use-cases of a SbW system and reduce the likelihood of needing to rely on a motion control strategy with less capability than RWA control systems.

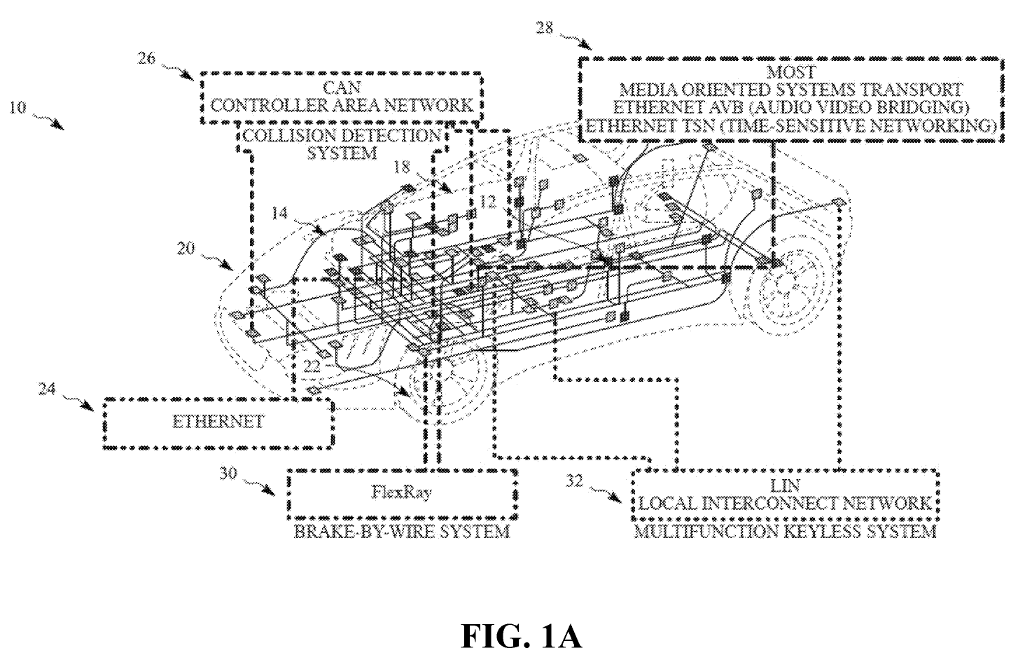

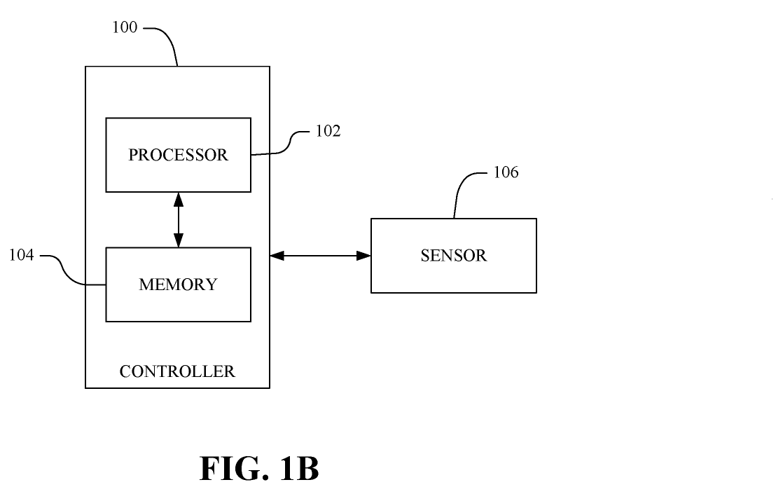

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B.

In some embodiments, the controller 100 may perform the methods described herein. However, the methods described herein as performed by the controller 100 are not meant to be limiting, and any type of software executed on a controller, processor, or other circuitry can implement the hysteresis shaping techniques described herein without departing from the scope of this disclosure. For example, a controller, such as a processor executing software within a computing device, can implement the systems and methods described herein.

Systems and methods according to the principles of the present disclosure (e.g., RWA control systems and methods) include, provide, and/or implement: an SbW vehicle model configured to determine an expected cornering state of the vehicle; calculation of an error between the expected cornering state and an actual cornering state (a cornering state error); and calculation an RWA control signal for directly controller the RWA (i.e., rather than providing control of the RWA via a RWA controller, rack position controller, etc.) For example, the SbW vehicle model may include one or both of an SbW model and a vehicle model (e.g., one of various types of vehicle models, such as a bicycle model, a dual track model, etc.).

The SbW vehicle model receives vehicle signals as inputs, such as vehicle speeds, wheel speeds, wheel or axle torques or forces, etc. The SbW vehicle model further receives a driver intent signal from the HWA, such as a handwheel or column angle, a handwheel or column torque, etc., indicative of the driver’s intended lateral control action. The SbW vehicle model calculates and outputs the expected cornering state of the SbW vehicle, such as an expected yaw rate, yaw acceleration, lateral acceleration, lateral velocity, etc.

To calculate the cornering state error, the expected cornering state may be compared to the actual cornering state (as obtained based on outputs from vehicle sensors) to calculate and output a cornering state error, such as a yaw rate error, yaw acceleration error, lateral acceleration error, lateral velocity error, etc.

To calculate the RWA control signal, a controller, control module, or control circuitry, processor configured to implement the functions described below, etc. (e.g., a closed-loop controller, such as a PID controller) receives the cornering state error and calculates the RWA control signal based on the cornering state error (and, in some examples, one or more other vehicle signals, such as vehicle speed, torque, etc.). The RWA control signal may include control parameters including but not limited to, motor torque, motor current, and/or motor voltage (e.g., of a motor and/or actuator of a steering rack or other components of an SbW steering system). The RWA control signal corresponds to a target output (e.g., a target rack position) that is provided to a motor controller associated with the RWA and/or provided directly to a RWA motor to generate a force to move a steered axle and cause lateral movement of the vehicle.

Previous techniques for determining a state of a currently operational motion control strategy typically rely on sensors and states inside the RWA. However, in these examples, if a position sensor for the steering rack is used to provide feedback by the RWA to determine whether RWA control results in rack movement, then a failure of that position sensor may result in a determination that RWA control of the rack steering rack is no longer feasible. In another example, if the RWA stops communicating to the HWA or to a domain controller, some methods may determine that RWA control of the rack is no longer feasible. However, in both of these examples, RWA control over the rack is still feasible (e.g., using open-loop strategies, vehicle level feedback strategies, etc.).

As one example, systems and methods according to the present disclosure are configured to implement a control strategy to calculate the RWA control signal in a manner that mitigates or compensates for RWA position sensor failure or failure of the RWA to communicate with the HWA, the domain controller, etc. More specifically, by comparing an expected cornering state of the vehicle to an actual cornering state of the vehicle, the described systems and methods are configured to control the RWA based on the driver intent.

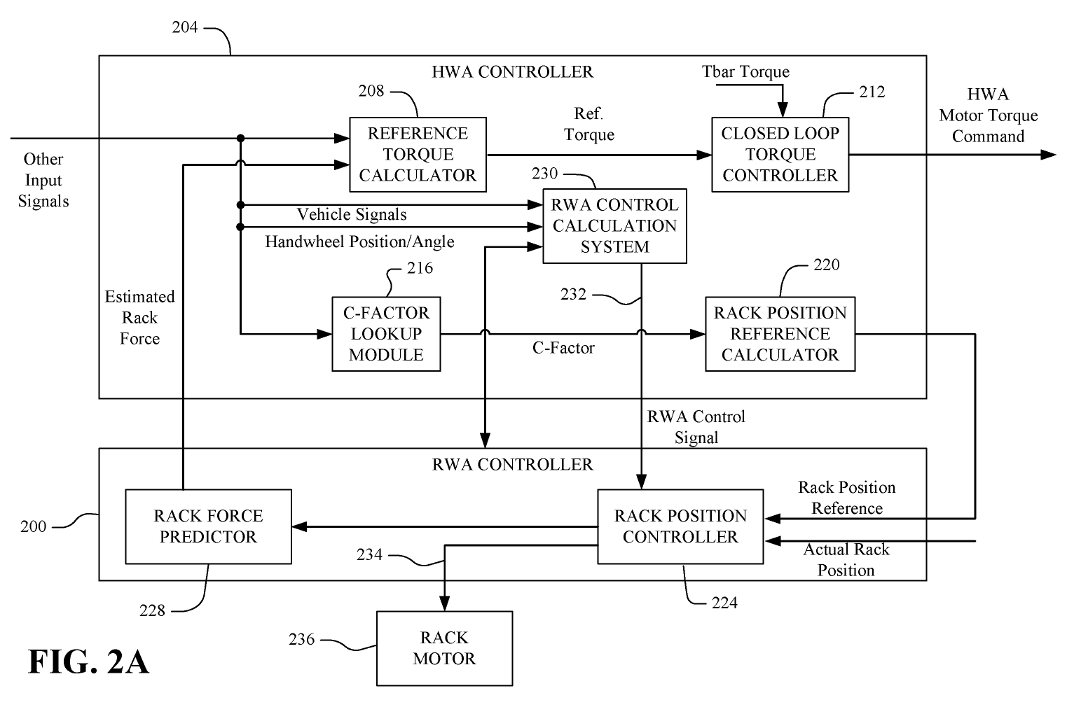

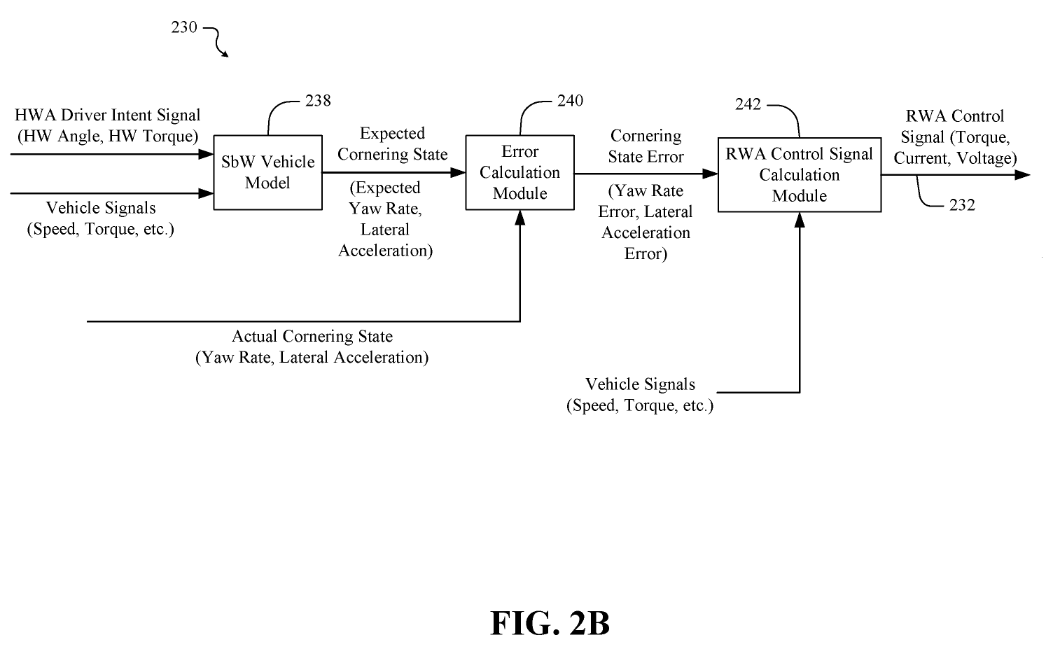

FIG. 2A illustrates an example rack or RWA controller 200 and column or handwheel actuator (HWA) controller 204 of a steering system configured to implement RWA control techniques according to the present disclosure. For example, the HWA controller 204 is configured to generate a handwheel actuator (HWA) motor torque command based on an estimated rack force (e.g., an estimated rack force signal) received from the RWA controller 200 and one or more other input signals (e.g., vehicle speed, handwheel position, and handwheel velocity). The RWA controller 200 is configured to determine the estimated rack force based on the motor torque required to achieve or maintain an actual rack position. The controllers 200 and 204 may correspond to, be implemented by, etc. one or more steering system controllers.

As one example, the HWA controller 204 includes a reference torque calculator 208 configured to calculate a reference torque (Tref) based on the estimated rack force and the one or more other input signals. For example, the reference torque corresponds to a sum of various inputs/measurements such as effort, hysteresis, return correction, damping, catch, etc. A closed loop (e.g., a PID closed loop) torque controller 212 is configured to generate and output the motor torque command based at least in part on a force or torque applied by the driver (e.g., “Tbar torque”) and the reference torque. The motor torque command is provided as a control signal to control a motor of the handwheel actuator.

The estimated rack force corresponds to the measured or estimated roadwheel actuator motor torque. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel). Example systems and methods for obtaining the rack position reference and the C-factor are described in more detail in U.S. Pat. App. No. 18/318,657, filed on May 16, 2023, the entire contents of which are incorporated herein by reference.

The RWA controller 200 includes a rack position controller 224 (e.g., a PID rack position controller) configured to generate one or more rack position control signals based on the actual rack position and the rack position reference (e.g., based on a difference between the actual rack positon and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position).

A rack force predictor 228 generates the estimated rack force based on outputs of the rack position controller 224 (e.g., based on a function of the rack motor velocity, the rack motor torque command, etc.). In various examples, the estimated rack force may be calculated based on the amount of torque applied to the handwheel by the driver (as indicated by the rack motor torque command, various sensor signals, etc.). As shown, the rack force predictor 228 may output the estimated rack force and the reference torque calculator 208 (and/or another component of the RWA controller 200, the HWA controller 204, etc.) may obtain an estimated rack load based on the estimated rack force. In other examples, the rack force predictor 228 may output the estimated rack load. In some contexts, the terms “estimated rack force” and “estimated rack load” may be used interchangeably.

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the roadwheel in hands-off conditions.

The reference torque may correspond to a desired, ideal, or target torque to be felt by the driver (i.e., at the handwheel/steering wheel). As described above, the reference torque is calculated based on inputs including, but not limited to, driver input (e.g., an input torque, corresponding to steering handwheel angle), road conditions, damping, hysteresis, etc. A torque at the hand wheel is controlled (e.g., via the HWA) to match the reference torque. For example, outputs of one or more sensors measuring actual torque at the wheel are used to minimize the difference between the reference torque and the actual torque.

An effort function (e.g., an effort function implemented by the reference torque calculator 208) defines a relationship between driver input (e.g., the force or torque applied by the driver to the handwheel, which may be referred to as “effort”) and a response (i.e., movement) of the steering system. For example, the effort function may output an effort value based on a lookup table or other function (e.g., by using an estimated rack load as an input). The estimated rack load may be modified prior to being input to the lookup table by adding a calculated return load value to the estimated rack load. The effort function indicates an amount of effort required by the driver to cause a desired response.

The HWA controller 204 according to the present disclosure includes an RWA control calculation system 230 configured to determine an expected cornering state of the vehicle, compare the expected cornering state to an actual cornering state, calculate an error between the expected cornering state and the actual cornering state, and selectively generate a signal to control vehicle steering based on the cornering state error.

For example, the RWA control calculation system 230 may generate and output an RWA control signal 232 configured to control rack position, roadwheels, etc. The RWA control signal 232 is separate/different from RWA control signals generated by or within the RWA controller 200. For example, as described above, the RWA controller 200 includes a rack position controller 224 configured to generate one or more rack position control signals to control rack motor velocity, motor torque, etc. As shown, rack position control signals may be represented by one or more motor control signals 234 provided to motors, actuators, etc. associated with controlling rack position, such as a rack motor 236. For example, the rack position controller 224 (e.g., a motor controller implemented by or responsive to the rack position controller 224) is configured to generate the motor control signals 234 to control the rack motor 236 to achieve desired movement/position of the steering rack.

In situations where the RWA controller 200, rack position controller 224, etc. are not controlling the rack motor 236, the RWA control calculation system 230 according to the present disclosure provides the RWA control signal 232 to control the rack motor 236. For example, failure of the RWA controller 200 to control the rack motor 236 may not necessarily indicate that the rack motor 236 itself, the rack, etc. are not operable to control vehicle steering. Rather, failure to control the rack motor 236 may be caused by failure of one or more sensors associated with the RWA controller, failure of communication between various components of the RWA controller 200 or to and from the RWA controller 200 (such as communication to and from the HWA controller 204 and/or another controller), etc. Accordingly, in these examples, RWA control of the rack motor 236 may still be feasible/possible in accordance with the principles of the present disclosure.

More specifically, the RWA control signal 232, generated external to the RWA controller 200, is configured to supersede or replace motor control signals generated by/within the rack position controller 224. For example, the RWA control system 230 generates the RWA control signal 232 to control the rack motor 236 in response to a determination that the RWA controller 200 is not effectively controlling the rack motor 236.

For example, the RWA control signal 232 is configured to control motor torque, current, voltage, etc. to achieve a desired (e.g., as indicated by driver intent) rack position/movement based on handwheel position/angle and/or other vehicle signals. The rack position controller 224 (e.g., a motor controller, which may be located external to the rack position controller 224, external to the RWA controller 200, etc.) receives the RWA control signal 232 and the motor control signals 234 are generated based on the RWA control signal 232. For example, the RWA control signal 232 may include an indication or command to use the RWA control signal 232 control signal to generate the motor control signals instead of using internal rack position controller calculations. In some example, the RWA control signals may correspond to motor control signals and may be provided directly to the rack motor 236 from the RWA control calculation system 230.

Although shown as being included within the HWA controller 204, some or all of the functions of the RWA control calculation system 230 may be located and/or implemented by other components of the vehicle, such as a domain controller, ECU, etc.

FIG. 2B shows an example of the RWA control calculation system 230 in more detail according to the principles of the present disclosure. For example only, the RWA control calculation system 230 may include and/or implement one or more computing devices, controllers, circuitry, etc. configured to perform the functions of the components described below. As shown, the RWA control calculation system 230 includes an SbW vehicle model 238, an error calculation module 240, and an RWA control signal calculation module 242.

The SbW vehicle model 238 is configured to calculate or determine an expected cornering state of the vehicle based on one or more inputs indicating driver intent. For example, driver intent may correspond on driver steering or lateral movement intent as indicated by movement of the handwheel, which may be referred to as HWA driver intent. As shown in FIG. 2B, HWA driver intent is indicated by a HWA driver intent signal, which may include one or more of HW (or column) angle and HW (or column) torque. Other input signals include, but are not limited to, vehicles signals such as vehicle speed and torque, wheel speed, wheel or axle torques or forces, etc.

The SbW vehicle model 238 is configured calculate and output the expected cornering state based on the HWA driver intent signal and/or, in some examples, the vehicle signals. For example, the expected cornering state may include or otherwise indicate an expected yaw rate of the vehicle, expected yaw acceleration, an expected lateral acceleration of the vehicle, expected lateral velocity, etc. In other words, the SbW vehicle model 238 is configured to determine one or more expected conditions of the vehicle (e.g., as expected to occur in response to the driver/HW input).

The error calculation module 240 is configured to calculate or determine a cornering state error based on the expected cornering state and an actual cornering state. For example, the actual cornering state may be obtained based on one or more various signals indicating actual vehicle conditions, such as signals obtained from respective sensors, calculations, etc. As one example, the actual cornering state may be calculated based on an actual yaw rate of the vehicle, actual yaw acceleration, an actual lateral acceleration of the vehicle, actual lateral velocity, etc. The error calculation module 240 compares the expected cornering state to the actual cornering state and calculates and outputs the cornering state error based on a difference between the expected cornering state and the actual cornering state. The cornering state error may include or indicate only a single error value (e.g., yaw rate error or lateral acceleration error) or multiple error values (e.g., both yaw rate error and lateral acceleration error). In some examples, the cornering state error may correspond to a combination of error values (e.g., an average of yaw rate error and lateral acceleration error).

The RWA control signal calculation module 242 is configured to calculate/generate the RWA control signal 232 based on the cornering state error and one or more other vehicle signals, such as handwheel position/angle and/or other signals indicative of driver intent. For example, the RWA control signal 232 is configured to control motor torque, current, voltage, etc. to achieve a desired (e.g., as indicated by driver intent) rack position/movement. As one example, the RWA control signal calculation module 242 compares the RWA control signal 232 to a cornering error threshold and generates the RWA control signal 232 in response to the cornering error threshold exceeding the cornering error threshold.

In this manner, the RWA control signal calculation module 242 is configured to generate the RWA control signal 232 to control rack position/movement (e.g., by controlling the rack motor 236) in response to a determination that the rack motor 236 is not responsive to the RWA controller 200.

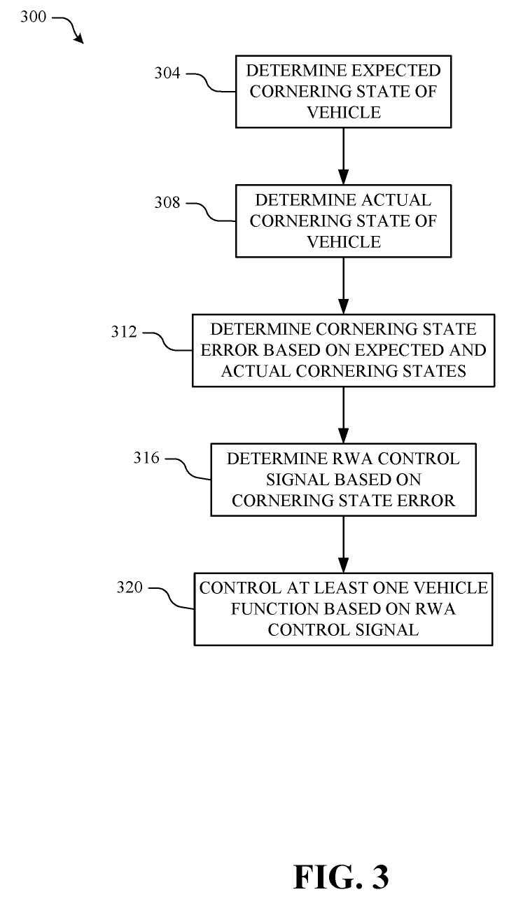

FIG. 3 is a flow diagram generally illustrating a method 300 for performing RWA control according to the principles of the present disclosure. For example, one or more computing devices, processors, or processing devices, etc. are configured to execute instructions to implement the method 300, such as one or more of the processors of the systems described herein (e.g., a computing device or processor of a vehicle configured to implement the controller 100, the RWA control calculation system 230, etc.). One or more of the steps of the method 300 as described below may be skipped or omitted in some examples, and/or one or more of the steps may be performed in a different sequence than described.

At 304, the method 300 includes determining an expected cornering state of a vehicle. At 308, the method 300 include determining an actual cornering state of the vehicle. At 312, the method 300 includes determining a cornering state error based on the expected cornering state and the actual cornering state.

At 316, the method 300 includes determining an RWA control signal based on the cornering state error and driver intent. In one example, determining the RWA control signal includes generating the RWA control signal in response to the cornering state error exceeding a threshold, and the RWA control signal indicates target motor voltage, current, torque etc. in accordance with driver intent.

At 320, the method 300 includes controlling at least one vehicle function based on the RWA control signal. For example, controlling the at least one vehicle function may include, but is not limited to, one or more of: controlling lateral movement/steering of the vehicle by controlling a rack motor based on the RWA control signal.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for controlling a roadwheel actuator (RWA) of a vehicle, the method comprising, using one or more processors:
determining an expected cornering state of the vehicle, wherein determining the expected cornering state includes determining at least one of an expected yaw rate an expected lateral acceleration of the vehicle;
determining an actual cornering state of the vehicle, wherein determining the actual cornering state includes determining at least one of an actual yaw rate and an actual lateral acceleration of the vehicle;
determining a cornering state error based on the expected cornering state of the vehicle and the actual cornering state of the vehicle;
generating an RWA control signal based on the cornering state error; and
controlling at least one function of the vehicle using the RWA control signal.

2. The method of claim 1, wherein determining the expected cornering state of the vehicle includes using a steer-by-wire vehicle model to obtain the expected cornering state based on one or more indications of driver intent.

3. The method of claim 2, wherein the one or more indications of driver intent include at least one of a handwheel angle and handwheel torque.

4. The method of claim 3, wherein obtaining the expected cornering status includes obtaining the expected cornering state based on at least one of vehicle speed, wheel speed, axle torque, braking torque, and a wheel torque.

5. The method of claim 1, wherein determining the cornering state error includes determining the cornering state error based on a difference between the expected cornering state of the vehicle and the actual cornering state of the vehicle.

6. The method of claim 1, wherein generating the RWA control signal includes generating the RWA control signal based on one or more signals indicative of driver intent.

7. The method of claim 1, further comprising controlling a rack motor to control lateral movement of the vehicle using the RWA control signal.

8. The method of claim 7, wherein generating the RWA control signal including generating the RWA control signal at a location in the vehicle external to an RWA controller.

9. A system for controlling a roadwheel actuator (RWA) of a vehicle, the system comprising:
one or more sensors configured to determine one or more operating characteristics of a vehicle; and
a processor configured to execute instructions stored in memory, wherein executing the instructions causes the processor to
determine an expected cornering state of the vehicle, wherein determining the expected cornering state includes determining at least one of an expected yaw rate an expected lateral acceleration of the vehicle,
determine, based on the one or more operating characteristics, an actual cornering state of the vehicle, wherein determining the actual cornering state includes determining at least one of an actual yaw rate and an actual lateral acceleration of the vehicle,
determine a cornering state error based on the expected cornering state of the vehicle and the actual cornering state of the vehicle,
generate an RWA control signal based on the cornering state error, and
control at least one function of the vehicle using the RWA control signal.

10. The system of claim 9, wherein determining the expected cornering state of the vehicle includes using a steer-by-wire vehicle model to obtain the expected cornering state based on one or more indications of driver intent.

11. The system of claim 10, wherein the one or more indications of driver intent include at least one of a handwheel angle and handwheel torque.

12. The system of claim 11, wherein obtaining the expected cornering status includes obtaining the expected cornering state based on at least one of vehicle speed, wheel speed, axle torque, braking torque, and a wheel torque and vehicle torque.

13. The system of claim 9, wherein determining the cornering state error includes determining the cornering state error based on a difference between the expected cornering state of the vehicle and the actual cornering state of the vehicle.

14. The system of claim 9, wherein generating the RWA control signal includes generating the RWA control signal based on one or more signals indicative of driver intent.

15. The system of claim 9, further comprising controlling a rack motor to control lateral movement of the vehicle using the RWA control signal.

16. The system of claim 15, wherein generating the RWA control signal including generating the RWA control signal at a location in the vehicle external to an RWA controller.

17. A system for controlling a roadwheel actuator (RWA) of a vehicle, the system comprising:
a processor configured to, using a steer-by-wire vehicle model, determine an expected cornering state of the vehicle, wherein determining the expected cornering state includes determining at least one of an expected yaw rate an expected lateral acceleration of the vehicle;
an error calculation module configured to, based on the expected cornering state of the vehicle and an actual cornering state of the vehicle, a cornering state error, wherein the actual cornering state of the vehicle is based on at least one of an actual yaw rate and an actual lateral acceleration of the vehicle; and
an RWA control signal calculation module configured to generate and output a RWA control signal based on the cornering state error.

18. The system of claim 17, further comprising a rack motor configured to control lateral movement of the vehicle, wherein the RWA control signal calculation module is configured to control the rack motor using RWA control signal.

19. The system of claim 17, wherein determining the expected cornering state of the vehicle includes using a steer-by-wire vehicle model to obtain the expected cornering state based on one or more indications of driver intent.

20. The system of claim 19, wherein the one or more indications of driver intent include at least one of a handwheel angle and handwheel torque.
